(19) United States
(12) Patent Application Publication
(10) Pub. No.: US 2018/0285591 A1
(43) Pub. Date: Oct. 4, 2018

(54) DOCUMENT REDACTION WITH DATA ISOLATION

(71) Applicant: CA, Inc., New York, NY (US)

(72) Inventors: Nicholas D. Thayer, Loveland, CO (US); James Andrew Perkins, Fort Collins, CO (US); Ward Duncan McKonly, Fort Collins, CO (US)

(21) Appl. No.: 15/473,550

(22) Filed: Mar. 29, 2017

(51) Int. Cl. G06F 21/62

(52) U.S. Cl. CPC G06F 21/6245

(57) ABSTRACT

A data security framework can be designed that allows separation of sensitive values from non-sensitive values while substituting obfuscation values for the sensitive values in a document that originally contained both. The data security framework detects a document/form being submitted to a server and determines those values of the document that are sensitive or confidential. The data security framework redacts the document to protect the sensitive values. The data security framework redacts the document by substituting the sensitive values in the document with obfuscation values. The data security framework stores the document or the values of the document (i.e., payload) with the substitute obfuscation values. The data security framework stores the sensitive values in a secure repository distinct from the repository in which the payload or document is stored.

### BACKGROUND

The disclosure generally relates to the field of data processing, and more particularly to protecting data in a cloud processing environment.

Data exchanged between a client and a server often contain sensitive information, such as a personal identifiable information. Securing the sensitive information while allowing the data to be shared is an increasingly complex task. Data obfuscation is the process of substituting the sensitive information with other data. This allows the data to be shared without the risk of exposing the sensitive information.

### BRIEF DESCRIPTION OF THE DRAWINGS

Aspects of the disclosure may be better understood by referencing the accompanying drawings.

FIG. 1 depicts an example framework or mechanism for obfuscating sensitive values in a document.

FIG. 2 is a flowchart of example operations for obfuscating sensitive values in a document.

FIG. 3 is a flowchart of example operations for obfuscating sensitive values in a document.

FIG. 4 is a flowchart of example operations for reconstructing sensitive values in a document.

FIG. 5 is a flowchart of example operations revealing sensitive values associated with obfuscation values.

FIG. 6 depicts an example computer system with an obfuscator/de-obfuscator.

### DESCRIPTION

The description that follows includes example systems, methods, techniques, and program flows that embody aspects of the disclosure. However, it is understood that this disclosure may be practiced without these specific details. For instance, this disclosure refers to submission of documents between a client and a server in illustrative examples. Aspects of this disclosure can be also applied to obfuscating documents stored in a data store. In other instances, well-known instruction instances, protocols, structures and techniques have not been shown in detail in order not to obfuscate the description.

Overview

Storing data in the cloud has been an increasingly common practice by organizations and individuals alike. However, while storing data in the cloud is efficient, storing data outside of the owner's realm raises security concerns because the owner relies on the service provider's security measures and implementation of those security measures. Encryption and obfuscation of the data stored in the cloud are commonly used techniques to alleviate these security concerns. Some data obfuscation techniques involve obfuscating data when responding to a query. This manner of data obfuscation can increase latency of the response. Moreover, the data is stored in its non-obfuscated form increasing the risk of data exposure. For example, a malicious user that gains access to a data store can query the data directly from the data store and bypass a client application interface that would obfuscate the data.

A data security framework can be designed that allows separation of sensitive values from non-sensitive values while substituting obfuscation values for the sensitive values in a document that originally contained both. The data security framework detects a document/form (hereinafter “document”) being submitted to a server and determines those values of the document that are sensitive or confidential (hereinafter referred to as “sensitive”). The data security framework redacts the document to protect the sensitive values. The data security framework redacts the document by substituting the sensitive values in the document with obfuscation values. The data security framework stores the document or the values of the document (i.e., payload) with the substitute obfuscation values. The data security framework stores the sensitive values in a secure repository distinct from the repository in which the payload or document is stored.

Example Illustrations

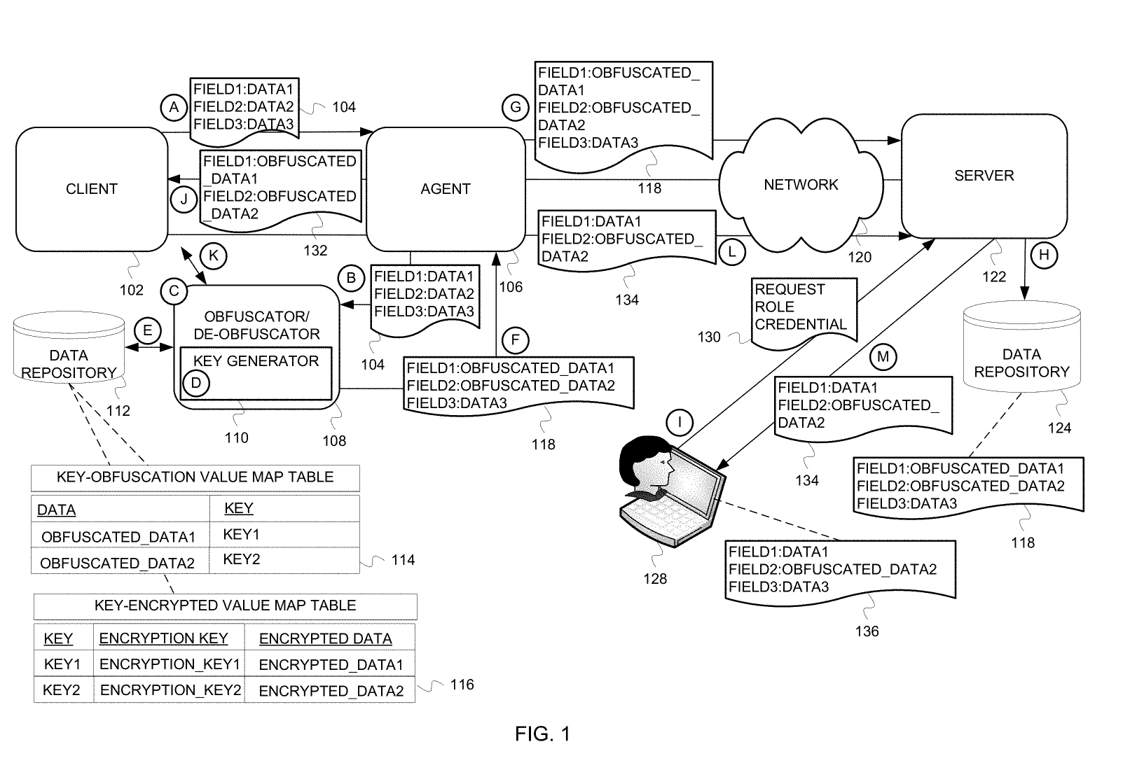

FIG. 1 depicts an example framework or mechanism for obfuscating sensitive values in a document. FIG. 1 comprises a client 102 that is communicatively coupled to an agent 106, a data repository 112, and an obfuscator/de-obfuscator 108 that includes a key generator 110. FIG. 1 also depicts a server 122 that is communicatively coupled to a data repository 124 and a client 128.

FIG. 1 is annotated with a series of letters A-M. These letters represent stages of operations, each of which may be one or more operations. Although these stages are ordered for this example, the stages illustrate one example to aid in understanding this disclosure and should not be used to limit the claims. Subject matter falling within the scope of the claims can vary with respect to the order of some of the operations.

Prior to stage A, the agent 106 was deployed to monitor submission of documents to the server 122. After deployment, the agent 106 begins monitoring for submission of documents from the client 102 to the server 122. The agent 106 may begin monitoring based on detecting an indication (e.g., indication of an application in a command or user interface, loading of an application into a browser application, etc.) of an upcoming document submission.

At stage A, the agent 106 detects an event triggered by the client's submission of a document 104 (hereinafter “submit event”) to the server 122. The submit event can be triggered in various ways. For example, the submit event can be triggered by clicking a submit button or sending a hypertext transfer protocol (HTTP) POST request. In this illustration, the submit event is detected prior to communication with the server 122 because redaction is done prior to communicating the document 104. Embodiments that perform redaction after communication of a document can detect the submission event after communication of a document. For example, an agent deployed at the server 122 can detect receipt of a document submitted by a client.

The document 104 contains data fields with associated data values. The associated data values comprise sensitive (e.g., personal identifiable information (PII)) and non-sensitive values. While depicted as a single document in FIG. 1, the document 104 may comprise multiple distinct or logically associated documents. Each of the documents may be structured as the document 104. The documents may also be different from the document 104, such as being unstructured (e.g., a text file) or semi-structured.

After detecting the submit event, at stage B, the agent 106 communicates the document 104 to the obfuscator/de-obfuscator 108. The agent 106 may communicate the document 104 to the obfuscator/de-obfuscator 108 through various means such as in a method or function call. At stage C, the obfuscator/de-obfuscator 108 receives and processes the document 104. Processing the document 104 comprises various procedures, such as determining whether the document 104 is to be secured. If the obfuscator/de-obfuscator 108 determines that the document 104 is to be secured then the obfuscator/de-obfuscator 108 proceeds with various other procedures such as determining the sensitive values contained in the document 104, generating obfuscation values, generating keys, and substituting the sensitive values with the obfuscation values. The obfuscator/de-obfuscator 108 determines the sensitive values through various means. For example, the obfuscator/de-obfuscator 108 may use at least one obfuscation criterion which specifies which data fields contain the sensitive values. The obfuscation criterion can be defined by an administrator of the client 102 and/or through a configuration setting or file. For example, a social security number field and residential address field may be defined as data fields that contain sensitive values. With a structured document like the document 104, the obfuscator/de-obfuscator 108 can select an obfuscation criterion based on a data field (e.g., data field identifier) or a tag that identifies a type of data value (e.g., PII) or a location or position (e.g., positional identifier) of the data value within the document 104.

At stage D, the obfuscator/de-obfuscator 108 generates obfuscation values that will be substituted for the sensitive values in the document 104. The obfuscator/de-obfuscator 108 may generate the obfuscation values based on a pre-determined obfuscation rule(s) (e.g., by applying an obfuscation algorithm). The obfuscation rules may be based on the sensitive values, data field, positional identifier, etc. In this example, the obfuscator generates a random set of alphanumeric characters as the obfuscation value. The framework generates the obfuscation values with a technique that allows collision avoidance, thus each obfuscation value is globally unique within the framework.

The key generator 110 generates unique keys that will be used to associate the obfuscation values with the sensitive values. The generated keys may be used to identify the obfuscation values. The key generator 110 may generate the keys in various ways. For example, the key generator 110 may hash the obfuscation values using hash techniques such as Secure Hash Algorithm (SHA). The key generator 110 may generate the keys independent of the sensitive values, based on the indications of the sensitive values (e.g., the data fields or positional identifiers of the sensitive values), and/or the sensitive values.

At stage E, the obfuscator/de-obfuscator 108 creates a mapping between the generated key, the obfuscation value, and the sensitive value and stores the mapping in the data repository 112. The sensitive value may be encrypted prior to the association and storage so as not to expose the sensitive value. The key generator 110 may create an encryption key to encrypt the sensitive value. The encryption key (e.g., a symmetric key) used in encrypting the sensitive value may also be stored in the data repository 112 and mapped to the encrypted sensitive value. The data repository 112 is a secure data repository under the control of an organization encompassing the client 102 and distinct from the data repository 124 which is under the control of a service provider corresponding to the server 122. If the encryption uses a public/private key pair, then the private key may be stored separately such as in a hardware security module. For instance, the obfuscator/de-obfuscator 108 updates an association table such as a key-obfuscation value map table 114 (hereinafter “table 114”) and a key-encrypted value map table 116 (hereinafter “table 116”) to map the generated key with the obfuscation values and the encrypted sensitive values respectively.

At stage F, the obfuscator/de-obfuscator 108 substitutes the sensitive values in the document 104 with the obfuscation values (hereinafter referred to as a “redacted document 118”). After the substitution, the obfuscator/de-obfuscator 108 transmits the redacted document 118 to the agent 106.

At stage G, the agent 106 transmits the redacted document 118 to the server 122 via a network 120. The agent 106 may transmit the redacted document 118 using various means such as a simple object access protocol (SOAP) or a representational state transfer (REST) application programming interface (API). Other protocols such as transport layer security (TLS) or secure sockets layer (SSL) may also be used. At stage H, the server 122 receives and stores the redacted document 118 in the data repository 124. The server 122 may store the redacted document 118 as a file or a record, for example.

At stage I, the client 128 establishes a session with the server 122 and transmits a request 130 to retrieve and view the redacted document 118. The request 130 includes a request to reveal the sensitive values that were substituted with the obfuscation values in the redacted document 118. The client 128 may be a device or a process running on a device as depicted in FIG. 1. The request 130 may include authorization and authentication information of the client 128 such as a role (e.g., director, administrator, project engineer), an identifier, and/or a credential (e.g., a password). The role may be defined by the client 102. The request is evaluated to determine whether the sensitive values that was substituted with the obfuscation values in the redacted document 118 can be revealed to the client 128.

At stage J, the server 122 retrieves the redacted document 118 from the data repository 124. The server 122 determines whether the redacted document 118 contains obfuscation values. For example, the server 122 may parse metadata in the redacted document 118 to determine the obfuscation values. In another example, the obfuscation values in the redacted document 118 may be tagged or flagged. After determining the obfuscation values, the server 122 then transmits a request to retrieve the sensitive values that were substituted to the client 102 via the network 120. The server 122 may transmit the request with a document 132 through various means such as a REST API request, SOAP request, etc. The server 122 may include the request 130 of the client 128 or other information for processing the request of the server. For example, the server 122 may include the authorization and authentication information of the client 128.

At stage K, the client 102 receives the document 132 with the request to retrieve the sensitive values corresponding to the obfuscation values. The client 102 may also receive the request 130 or the authorization and authentication information of the client 128 (e.g., role and credential of the client 128). The client 102 transmits the document 132 to the obfuscator/de-obfuscator 108 for processing. Processing includes determining the authorization and authenticating the credentials of the client 128. Processing also includes determining the constraints by which the sensitive values associated with the obfuscation values in the request can be revealed. For example, revealing the sensitive values may be constrained by the authority of the role of which the client 128 is a member. Different roles may be associated with different permissions to reveal different sensitive values and/or types of sensitive values. For example, an administrator role may have permission to view all of the sensitive values; whereas a project manager role may have permission to view some of the sensitive values such as internet protocol (IP) addresses but not credit card numbers. A role may have a 1:1 or 1:n association with permissions.

The obfuscator/de-obfuscator 108 may determine the permission associated with the role using various services such as a security policy server, an active directory, etc. A role server or an application component (not depicted) can also be configured to manage the association of permissions with roles. In another example, a role-permissions association list may be maintained.

In this example, after authenticating the client 128, the obfuscator/de-obfuscator 108 determines the authorization of the client 128. Determining the authorization of the client 128 includes determining the role membership of the client 128 and the permissions associated with the role. In this example, the role that the client 128 is a member of has permission to reveal the sensitive value associated with a data field “FIELD1”. The obfuscator/de-obfuscator 108 then determines if any of the obfuscation values received from the client 102 is associated with the data field FIELD1. After determining that data field FIELD1 is associated with an obfuscation value “OBFUSCATED_DATA1,” the obfuscator/de-obfuscator 108 queries the table 114 to retrieve the key “KEY1” associated with the obfuscation value OBFUSCATED_DATA1. After identifying the associated key, the obfuscator/de-obfuscator 108 queries the table 116 to determine and decrypt an encrypted sensitive value “ENCRYPTED_DATA1.” The obfuscator/de-obfuscator 108 decrypts the encrypted sensitive value ENCRYPTED_DATA1 using an associated encryption key “ENCRYPTION_KEY1” revealing a sensitive value “DATA1.” The obfuscator/de-obfuscator 108 substitutes the obfuscation value OBFUSCATED_DATA1 with the decrypted sensitive value DATA1 in a document 134 and communicates the document 134 to the client 102.

At stage L, the client 102 transmits the document 134 to the server 122 via the network 120. The client 102 may transmit the document 134 via a REST API or SOAP response to the earlier received REST API or SOAP request. At stage M, the server 122 receives and processes the document 134. Processing the document 134 includes substituting the obfuscation values in the retrieved redacted document 118 with the sensitive values contained in the document 134. In this example, the server 122 substitutes the values in the redacted document 118 with the values in the document 134 to yield a document 136, which reveals the sensitive value DATA1 to the client 128. Thus, the document 136 comprises the revealed sensitive value, the obfuscation value not authorized to be revealed, and the non-sensitive value.

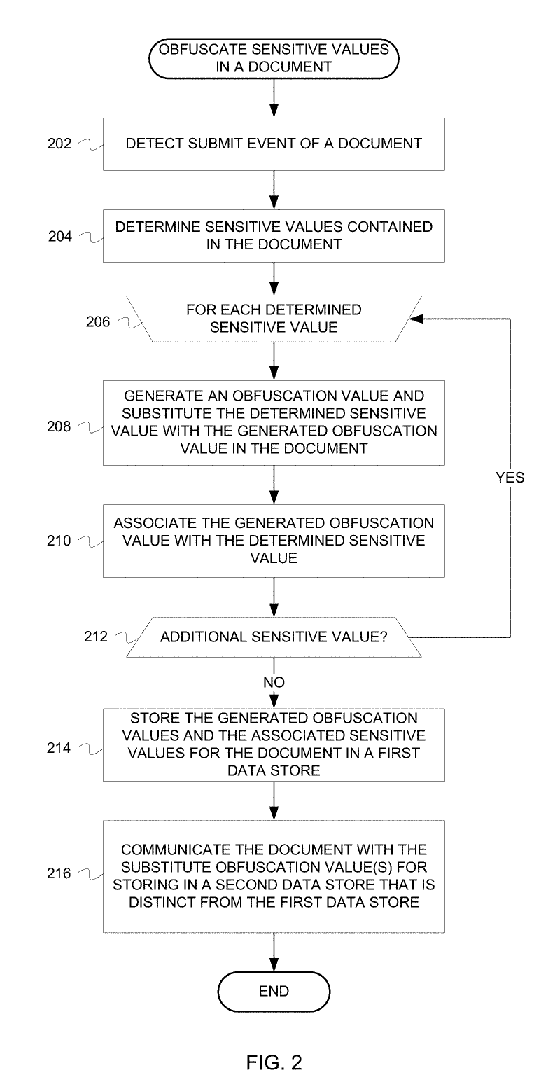

FIG. 2 is a flowchart of example operations for obfuscating sensitive values in a document. The description in FIG. 2 refers to an agent and an obfuscator/de-obfuscator as performing the example operations for consistency with FIG. 1.

An agent detects a submit event to transmit a document from a client to a server (202). As stated earlier, the submit event is generated when a defined action has occurred, such as clicking a submit button in a graphical user interface. Additionally, the submit event may have been generated in response to a method call; a command received via a command line; or an API call. The agent may be configured to listen for events associated with submission of documents by a client or an on-premise server to an off-premise server, for example.

After detecting the submit event, the agent communicates the document to an obfuscator/de-obfuscator to determine sensitive values contained in the document (204). As stated earlier, the obfuscator/de-obfuscator may determine the sensitive values using at least one obfuscation criterion, such as a criterion based on a data field descriptor or position of a data value. The obfuscator/de-obfuscator may also use other techniques to determine sensitive values, such as semantic analysis, obfuscation rules, heuristics, supplemental dictionaries, pattern matching, etc. The obfuscator/de-obfuscator may also combine any of these techniques. The techniques used by the obfuscator/de-obfuscator may depend on the type or structure of the document. For example, if the document is unstructured, the obfuscator/de-obfuscator can also include or invoke program code that parses and semantically analyzes the text or data in the unstructured document to determine the sensitive values. If the document is semi-structured, the obfuscator/de-obfuscator may use a combination of techniques to determine the sensitive values such as parse the data in the unstructured section of the document and use the data field descriptors in the structured section of the document.

Each document may also belong to a certain category or type. In addition to a document having a unique identifier, a document may be assigned a category or type identifier. Each category or type may be associated with a program(s) or program code for processing. For example, a website may contain a web form for account information (hereinafter “account form”). The obfuscator/de-obfuscator determines a function associated with account forms. The obfuscator/de-obfuscator uses the function to determine the sensitive values in the account forms. In some examples, the obfuscator/de-obfuscator performs pre-processing functions such as filtering (sometimes referred to as “cleaning”) and/or structurally preparing the document for processing. For example, the obfuscator/de-obfuscator may remove extraneous information from the document, such as information in headers.

The obfuscator/de-obfuscator then redacts each determined sensitive value from the document (206). The redaction process involves generating an obfuscation value and associating the obfuscation value with the sensitive value to allow restoration when permitted. The sensitive value currently being processed by the obfuscator/de-obfuscator is hereinafter referred to as the “selected sensitive value.” The obfuscator/de-obfuscator generates an obfuscation value and substitutes the selected sensitive value with the generated obfuscation value in the document (208). The obfuscator/de-obfuscator may generate the obfuscation value based on the sensitive value (e.g., compute a hash with the sensitive value as input) or generate the obfuscation value independently of the sensitive value. The obfuscator/de-obfuscator may generate the obfuscation value from globally unique random alphanumeric characters, follow at least one pre-determined obfuscation criterion, obfuscation rule, heuristic, etc. The obfuscation criterion may be based on the data field (e.g., user name, password, credit card number, etc.), the location of the selected sensitive value in the document, etc. The obfuscation value may also be a static value that is used to mask the selected sensitive value. For example, the obfuscation value may be a series of characters (e.g., series of X's), the length of which may be fixed depending on the length of the selected sensitive value or part of the selected sensitive value to be obfuscated. The obfuscator/de-obfuscator may also be a text that appears similar to the selected sensitive value. For example, instead of replacing a credit card number with random characters, the obfuscator/de-obfuscator may replace the credit card number with a random fake credit card number that looks like a real credit card number.

The obfuscation criterion may be based on a sensitivity and/or a privacy level of the selected sensitive value. The sensitivity level and/or privacy level of the selected sensitive value may be pre-defined in a configuration or properties file or determined by analyzing the value against heuristic or rules (e.g., a value has a format matching a bank account format). For example, a social security number may have a higher sensitivity level than a zip code. The obfuscator/de-obfuscator may apply a different obfuscation rule when obfuscating the social security number (e.g., use dummy or honey pot values) than the zip code (e.g., replace the last n numbers of a zip code).

The obfuscator/de-obfuscator may also generate obfuscation values for sections or parts of a document. For example, a highly confidential section of a document may be substituted with the generated obfuscation values regardless whether all of the data contained in the highly confidential section are considered sensitive or not.

After generating the obfuscation value, the obfuscator/de-obfuscator associates the generated obfuscation value with the selected sensitive value (210). The obfuscator/de-obfuscator can generate a map which maps/associates obfuscation values to corresponding substituted sensitive values. An entry in the map may be an identifier of the selected sensitive value instead of the selected sensitive value. The map can correlate an identifier to the selected sensitive value without exposing the selected sensitive value. The map can be implemented as a table, tabular records, an associative array, etc.

The obfuscator/de-obfuscator determines if there is an additional sensitive value to be processed (212). If there is an additional sensitive value to be processed, then the next sensitive value is selected (206). If there is no additional sensitive value to be processed, then the obfuscator/de-obfuscator stores the generated obfuscation values and the associated sensitive values in a first data store (214). The obfuscator/de-obfuscator may create the map/associations in-memory and then persist the map into the first data store. When stored, the obfuscator/de-obfuscator associates or indexes the collection of associated values with an identifier of the document. For example, the table or structure can be created per document. As another example, a database can store entries for each redacted document and each document entry references or indexes into an entry or entries with the associations or mappings of obfuscation values and substituted sensitive values. Embodiments can update the first data store during the redaction process instead of after it completes. The first data store is a secure data repository which may be controlled by an organization encompassing the client. The first data store may be secured using various techniques. For example, the first data store may be physically located in a secured facility. Further, access to the first data store may be limited to certain users. Strong authentication technologies (e.g., smart cards, tokens) may be implemented. In another example, the sensitive values may be signed prior to storage in the first data store. Thus, only authorized users may be able to retrieve the sensitive values in the first data store. In addition, cryptographic techniques such as Public Key Infrastructure (PKI) with Rivest-Shamir-Adleman (RSA) public/private key pairs along with digital signatures and checksums may be leveraged in securing the first data store.

The obfuscator/de-obfuscator then communicates the redacted document (i.e., the document with the substitute obfuscation value(s)) for storage in a second data store that is distinct from the first data store (216). The second data store is separated physically or logically from the first data store. The second data store may be under the control of an organization or provider that controls the server or located in the cloud. The second data store may have fewer security protocols in place than the first data store. For example, documents stored in the second data store may be accessed by the public using an API.

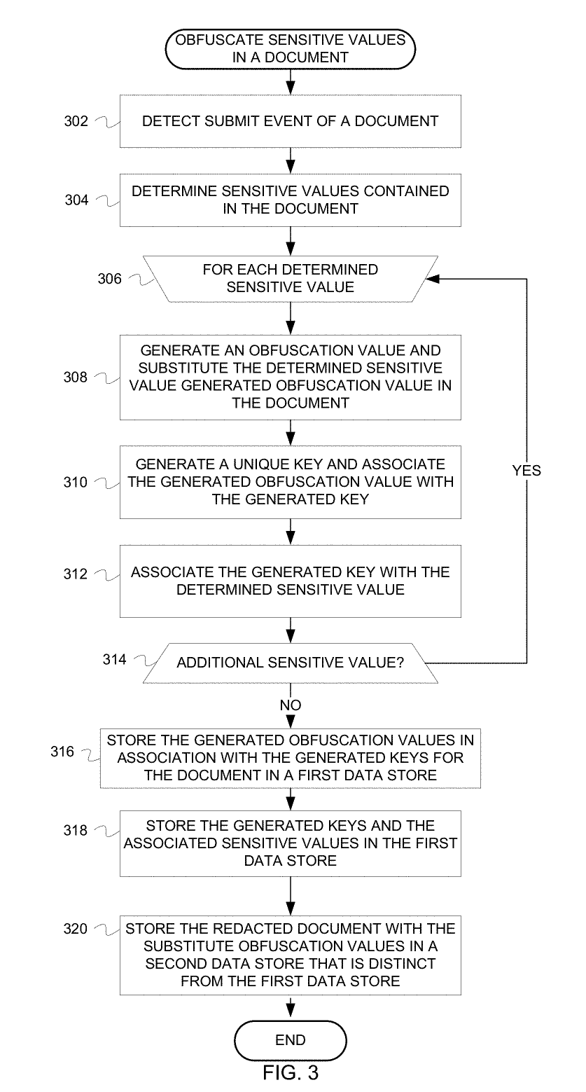

FIG. 3 is a flowchart of example operations for obfuscating sensitive values in a document. The description in FIG. 3 refers to an agent and an obfuscator/de-obfuscator as performing the example operations for consistency with FIG. 1. FIG. 3 is similar to FIG. 2, except in block 210 of FIG. 2, a generated obfuscation value is associated with a determined sensitive value. However, in block 310 of FIG. 3, the generated obfuscation value is associated with a generated key. The generated key is then associated with the determined sensitive value.

An agent detects a submit event to transmit a document from a client to a server (302). As stated earlier, the submit event is generated when a defined action has occurred, such as clicking a submit button in a graphical user interface. Additionally, the submit event may have been generated in response to a method call; a command received via a command line or an API call. The agent may be configured to listen for events associated with submission of documents by a client or an on-premise server to an off-premise server for example.

After detecting the submit event, the agent communicates the document to an obfuscator/de-obfuscator to determine sensitive values contained in the document (304). As stated earlier, the obfuscator/de-obfuscator may determine the sensitive values using at least one obfuscation criterion based on a data field descriptor or position of a data value. The obfuscator/de-obfuscator may also use other techniques to determine sensitive values such as semantic analysis, obfuscation rules, heuristics, supplemental dictionaries, pattern matching, etc. The obfuscator/de-obfuscator may also combine any of these techniques. The techniques used by the obfuscator/de-obfuscator may depend on the type or structure of the document.

Each document may also belong to a certain category or type. In addition to assigning a unique identifier to each document, each category or type may be assigned a unique identifier. Each category or type may be associated with a program(s) or program code for processing. For example, a website may contain an account form. The obfuscator/de-obfuscator determines a function associated with account forms. The obfuscator/de-obfuscator uses the function to determine the sensitive values in the account forms.

In some examples, the obfuscator/de-obfuscator performs pre-processing functions such as cleaning and/or structurally preparing the document for processing. For example, the obfuscator/de-obfuscator may remove extraneous text from the document such as headers.

The obfuscator/de-obfuscator then redacts each determined sensitive value (306). The redaction process involves generating an obfuscation value and a key and associating the obfuscation value with the key. The key is associated with the sensitive value to allow restoration when permitted. The sensitive value currently being processed by the obfuscator/de-obfuscator is hereinafter referred to as the “selected sensitive value.” The obfuscator/de-obfuscator generates an obfuscation value and substitutes the selected sensitive value with the generated obfuscation value in the document (308). As stated earlier, the obfuscator/de-obfuscator may generate the obfuscation value based on the sensitive value or generate the obfuscation value independently of the sensitive value. The obfuscator/de-obfuscator may generate the obfuscation value from globally unique random alphanumeric characters, follow at least one pre-determined obfuscation criterion, obfuscation rule, heuristic, etc. The obfuscation criterion may be based on the data field the location of the selected sensitive value in the document, etc. The obfuscation value may also be a static value that is used to mask the selected sensitive value. The obfuscator/de-obfuscator may also be a text that appears similar to the selected sensitive value.

The obfuscation criterion may be based on a sensitivity and/or a privacy level of the selected sensitive value. The sensitivity level and/or privacy level of the selected sensitive value may be pre-defined in a configuration or properties file or determined with content/semantic analysis (e.g., the value has the formatting of a social security number). The obfuscator/de-obfuscator may apply a different obfuscation rule for values of different sensitivity levels.

After generating the obfuscation value, the obfuscator/de-obfuscator generates a globally unique key and associates the generated obfuscation value with the generated key (310). The obfuscator/de-obfuscator can generate a map that associates/maps the generated obfuscation values to corresponding generated keys. The association may also be represented in a table that associates the generated obfuscation value with the generated key. The map can be implemented as a table, tabular records, an associative array, etc.

After associating the generated key and the generated obfuscation value, the obfuscator/de-obfuscator associates the generated key with the selected sensitive value (312). Similar to block 310, the obfuscator/de-obfuscator can generate a map that associates/maps the generated key to the corresponding selected sensitive value. The map can be implemented as a table, tabular records, an associative array, etc.

The obfuscator/de-obfuscator determines if there is an additional sensitive value to be processed (314). If there is an additional sensitive value to be processed, then the next sensitive value is selected (306). If there is no additional sensitive value to be processed, then the obfuscator/de-obfuscator stores the generated obfuscation values and the associated generated keys in a first data store (316). The obfuscator/de-obfuscator may create the map/associations in-memory and then persist the map into the first data store. When stored, the obfuscator/de-obfuscator associates or indexes the collection of associated values with an identifier of the document. Embodiments can update the first data store during the redaction process instead of after it completes. As stated earlier the first data store is a secure data repository which may be controlled by an organization encompassing the client. The obfuscator/de-obfuscator also stores the generated keys and associated sensitive values in the first data store (318). The obfuscator/de-obfuscator may create the map/associations in-memory and then persist the map into the first data store. Thus, restoring a sensitive value in a document would involve looking up a key associated with an obfuscation value, and then looking up with the key the sensitive value that was redacted out of the document.

The obfuscator/de-obfuscator then communicates the redacted document for storage in a second data store that is distinct from the first data store (320). The second data store is separated physically or logically from the first data store. The second data store may be under the control of an organization or provider that controls the server or located in the cloud. The second data store may have fewer security protocols in place than the first data store.

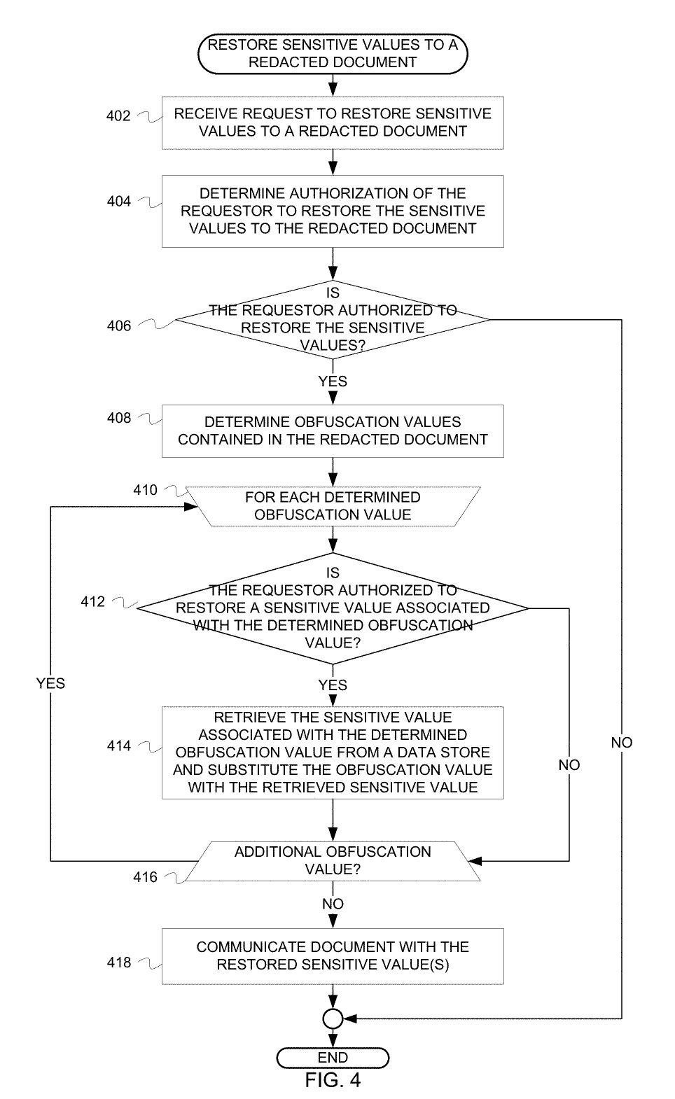

FIG. 4 is a flowchart of example operations for reconstructing sensitive values in a document. The description in FIG. 4 refers to an obfuscator/de-obfuscator of FIG. 1 as performing the example operations for consistency with FIG. 1.

Prior to the receipt of a request to restore sensitive values by an obfuscator/de-obfuscator, the request to restore the obfuscation values in a redacted document was made by a requestor (e.g., a user, a client, etc.) to a server. The server transmits the request with the redacted document to a client that has ownership or initially transmitted the redacted document to the server. The server may transmit the request to the client via an agent. The request may include an identifier of the redacted document or a reference to the redacted document instead of the redacted document. In another example, the request may include the obfuscation values instead of the redacted document. The request may also include other information such as obfuscation value identifiers, location identifiers of the obfuscation values, data fields associated with the obfuscation values, or data field identifiers associated with the obfuscation values. The server also includes authorization and authentication information of the user. The client communicates the request with the information included in the request to the obfuscator/de-obfuscator.

An obfuscator/de-obfuscator receives the request to restore sensitive values to the redacted document from the client (402). The obfuscator/de-obfuscator may receive the request through various means such as a function call, a SOAP request or a REST API request. If an identifier of the requestor is included in the request instead of the requestor's authorization and authentication information. The obfuscator/de-obfuscator may use the requestor's identifier to retrieve the requestor's authorization information (e.g., a role associated with the requestor).

After receiving the request, the obfuscator/de-obfuscator determines authorization of the requestor to restore the sensitive values to the redacted document (404). Granularity of authorization for restoring sensitive values can vary by roles, by document type, by system, etc. For example, the requestor can be authorized to restore sensitive values for a particular section of a document or for particular types of sensitive values. The authority or permission may be based on the type of the redacted document, data fields, location of the obfuscation values in the redacted document, etc. For example, a software engineer role may have the authority to restore IP addresses but not social security numbers. An administrator role may have the authority to restore IP addresses and social security numbers.

If the requestor is not authorized to restore the sensitive values to the redacted document (406), then the process ends. If the requestor is authorized to restore the sensitive values to the redacted document (406), the obfuscator/de-obfuscator determines the obfuscation values contained in the redacted document (408). The obfuscator/de-obfuscator may determine the obfuscation values in the redacted document by traversing the data fields in the redacted document. The obfuscator/de-obfuscator may have tagged or flagged the data fields that contains obfuscation values in the redacted document prior to storage. For example, the redacted document may have been modified to include tags or flags to indicate the obfuscation values prior to storage. The obfuscator/de-obfuscator may also identify the data fields that contain obfuscation values from a pre-defined list. The pre-defined list may be updated by an administrator or generated dynamically by the obfuscator/de-obfuscator in accordance with obfuscation criteria and/or obfuscation rules. The obfuscator/de-obfuscator may also determine the obfuscation values using metadata of the redacted document. The metadata of the redacted document may have been updated to indicate the obfuscation values and/or the data fields that contains the obfuscation values.

After determining the obfuscation values in the redacted document, the obfuscator/de-obfuscator begins processing each determined obfuscation value (410). The obfuscation value currently being processed by the obfuscator/de-obfuscator is hereinafter referred to as the “selected obfuscation value.” To process each selected obfuscation value, the obfuscator/de-obfuscator determines if the requestor is authorized to restore the sensitive value associated with the selected obfuscation value (412). The prior determination of authorization (406) was a document level determine as to whether the requestor is authorized to restore any sensitive value to the redacted document. Since a document can contain values of varying sensitivity levels, authorization in this illustration is also done at the individual sensitive value level. When determining that the requestor was authorized the restore sensitive values for the document, the authorization process can obtain indications of the type of sensitive values authorized to be restored for the requestor.

If the requestor is not authorized to restore the sensitive value associated with the selected obfuscation value, the obfuscator/de-obfuscator determines if there is an additional obfuscation value (416). If the requestor is authorized to restore the sensitive value associated with the selected obfuscation value, the obfuscator/de-obfuscator retrieves the sensitive value associated with the selected obfuscation value (414). The obfuscator/de-obfuscator may retrieve the sensitive value associated with the selected obfuscation value from a data repository with a query that includes the selected obfuscation value as a query parameter. If the retrieved sensitive value is encrypted, the obfuscator/de-obfuscator decrypts the retrieved sensitive value. The obfuscator/de-obfuscator substitutes the selected obfuscation value in the redacted document with the retrieved sensitive value yielding a substituted document.

If there is an additional obfuscation value, the obfuscator/de-obfuscator selects the next obfuscation value (410). If there is no additional obfuscation value, the obfuscator/de-obfuscator communicates to the client the substituted document (418). The client transmits the substituted document to the server. The client may transmit the substituted document via an agent. The client may transmit the substituted document via a REST API or SOAP response for example. The server communicates the substituted document to the requestor.

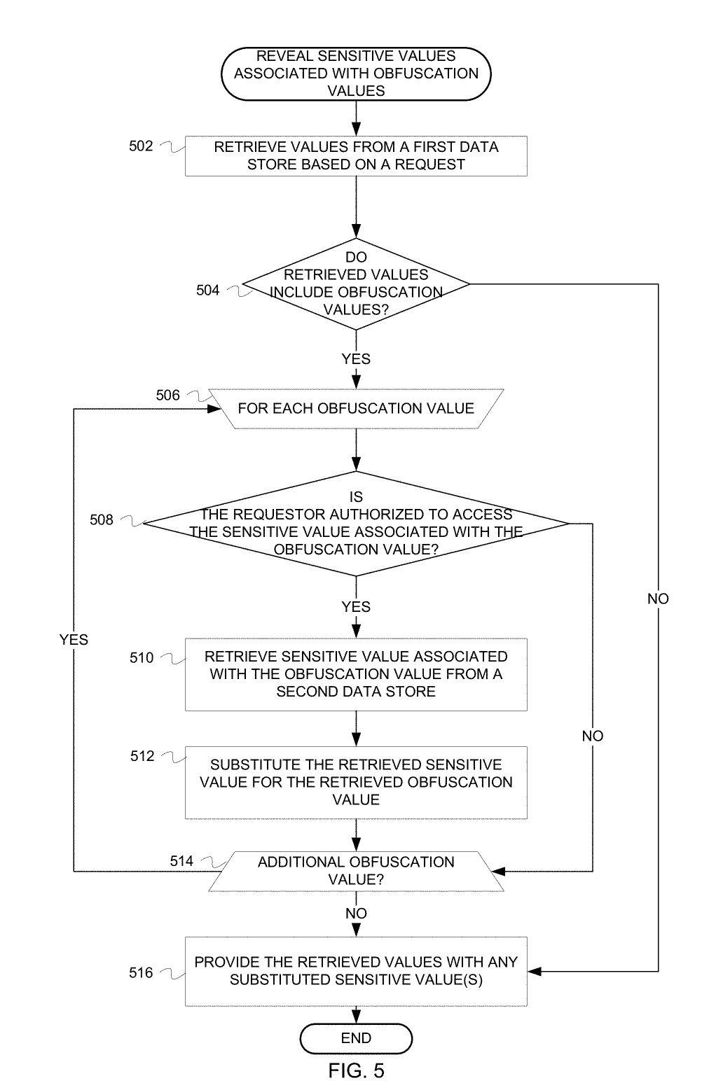

FIG. 5 is a flowchart of example operations revealing sensitive values associated with obfuscation values. The example operations of FIG. 5 relate to accessing a data store (e.g., database) that has obfuscated values and non-obfuscated values extracted from submitted documents. In contrast to retrieval of a document as in FIG. 4, these example operations retrieve values, which may include obfuscated values, based on a request or query. For example, instead of redacting and storing a redacted account form that has been submitted, the redacted payload of the account form is extracted and stored in a data repository. The values are not stored for document retrieval from answering a query. Values, both obfuscated and non-obfuscated, retrieved in response to a request or query on the data store may have been extracted from different submitted documents. The description in FIG. 5 refers to an obfuscator/de-obfuscator and a server in FIG. 1 as performing the example operations for consistency with FIG. 1.

A server retrieves values from a second data store based on a data request (502). The data request may be a query with one or more parameters. The second data store contains the obfuscated values and non-obfuscated values extracted from submitted documents. The server may receive the data request through various means such as a function call, SOAP request or a REST API request.

The server determines if the retrieved values include obfuscation values (504). The server may have tagged or flagged a data column(s) that contains the obfuscation values. In another example, a table of data column names that contains the obfuscation values may be maintained. The server may also identify the data column names that contain the obfuscation values from a pre-defined list. If there are no obfuscation values retrieved, the server communicates the retrieved value(s) to a requestor (516).

If the retrieved values include the obfuscation values (504), the server sends a request to an obfuscator/de-obfuscator in an organization that owns the retrieved obfuscation values to reveal sensitive values associated with the obfuscation values via a client the organization. The server may send the request through various means such as a function call, SOAP request or a REST API request. The request may include additional information about the obfuscation value such as the data column names and/or identifiers of the data columns that contained the obfuscation value, identifiers of the obfuscation values, etc. The request may include authorization and authentication information of the requestor. In another example, the request may include an identifier of the requestor. The obfuscator/de-obfuscator may then use the identifier of the requestor to retrieve the requestor's authorization information (e.g., a role associated with the requestor) from a role server for example.

The obfuscator/de-obfuscator begins processing each obfuscation value (506) for possible reveal of a corresponding sensitive value. The obfuscation value currently being processed by the obfuscator/de-obfuscator is hereinafter referred to as the “selected obfuscation value.” To process each selected obfuscation value, the obfuscator/de-obfuscator determines if the requestor is authorized to access or view the sensitive value associated with the selected obfuscation value (508). The obfuscator/de-obfuscator may gather information associated with the requestor to determine if the requestor has permission to access the sensitive value associated with the selected obfuscation value. As stated earlier, when determining that the requestor was authorized to access sensitive values, the authorization process can obtain indications of the type of sensitive values authorized to be accessed by the requestor.

If the requestor is not authorized to access the sensitive value associated with the selected obfuscation value, the obfuscator/de-obfuscator determines if there is an additional obfuscation value (514). If the requestor is authorized to access the sensitive value associated with the selected obfuscation value, the obfuscator/de-obfuscator retrieves the sensitive value associated with the selected obfuscation value from a first data store (510). The first data store is a secure data repository where the sensitive values associated with the obfuscation values are stored. The first data store is distinct physically and/or logically from the second data store. If the retrieved sensitive value is encrypted, the obfuscator/de-obfuscator decrypts the retrieved sensitive value. The obfuscator/de-obfuscator substitutes the selected obfuscation value with the retrieved sensitive value (512).

If there is an additional obfuscation value, the obfuscator/de-obfuscator selects the next obfuscation value (506). If there is no additional obfuscation value, the obfuscator/de-obfuscator sends a response with the substituted sensitive values to the server via the client (516). The server may send the response according to the request received, such as a function call, SOAP response or a REST API response. The server then provides the retrieved values with the substituted sensitive values to the requestor.

Variations

Embodiments can pre-process a query based on indication of obfuscation values in the data store. For instance, a query may be for all bank accounts of users in a particular zip code. The process handling the query (e.g., a database process or server process) can initially determine if any of the query parameters are on an obfuscated category of data. If so, then the query can be rejected or authentication and authorization can be performed to determine whether secured retrieval of sensitive values can be performed, dependent upon the authorization and authentication result, to process the query. The secured retrieval can be done by a separate secured process that has access to the sensitive values in the secured data store and return only those sensitive values satisfying the query parameters to the serving process, again assuming satisfaction of authorization and authentication.

The examples often refer to an agent and an obfuscator/de-obfuscator. These are both constructs used to refer to example implementations of program code. An agent is program that performs the functionality as described herein as being performed by an agent. Similarly, an obfuscator/de-obfuscator is program that performs the functionality described herein as being performed by an obfuscator/de-obfuscator. These constructs are utilized for efficient explanation since numerous implementations are possible.

The examples refer to an agent detecting submission of a document with an on-premise redaction of a document. The agent may instead detect receipt of the document with an off-premise redaction of a document (i.e., redaction of a document after the document is transmitted). For example, an agent may be deployed in an off-premise server. The agent detects receipt of a document submitted by a client or an on-premise server. The received document is then redacted off-premise prior to storage.

The examples refer to a client and/or an on-premise server initiating the submission of a document. The submission of a document may also be in response to a request from an on-premise or off-premise server. For example, the on-premise server may periodically transfer documents from the client to an off-premise server for backup.

The examples refer to associating sensitive values with obfuscation values and storing the association in a secure database. The association of the sensitive values with the obfuscation values may instead be reflected with a mapping of attributes of the obfuscation values such as tags or names of the obfuscation values, location identifiers of the obfuscation values, data field identifiers of the obfuscation values, keys associated with the obfuscation values, etc. to the corresponding sensitive values. The mapping is used to determine the sensitive values associated with the obfuscation values. The mapping may be stored in a secure repository that also contains the obfuscation values and the sensitive values. In another example, the mapping may be stored in a repository (i.e., a third repository) distinct physically and/or logically from the repository that contains the obfuscation values and the sensitive values, and from a repository that contains the redacted document. Similar to the repository that contains that obfuscation values and the sensitive values, the third repository may be more secure than the repository that contains the redacted document. The third data store may be controlled by an organization encompassing a client that owns the redacted document.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 318 and 320 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

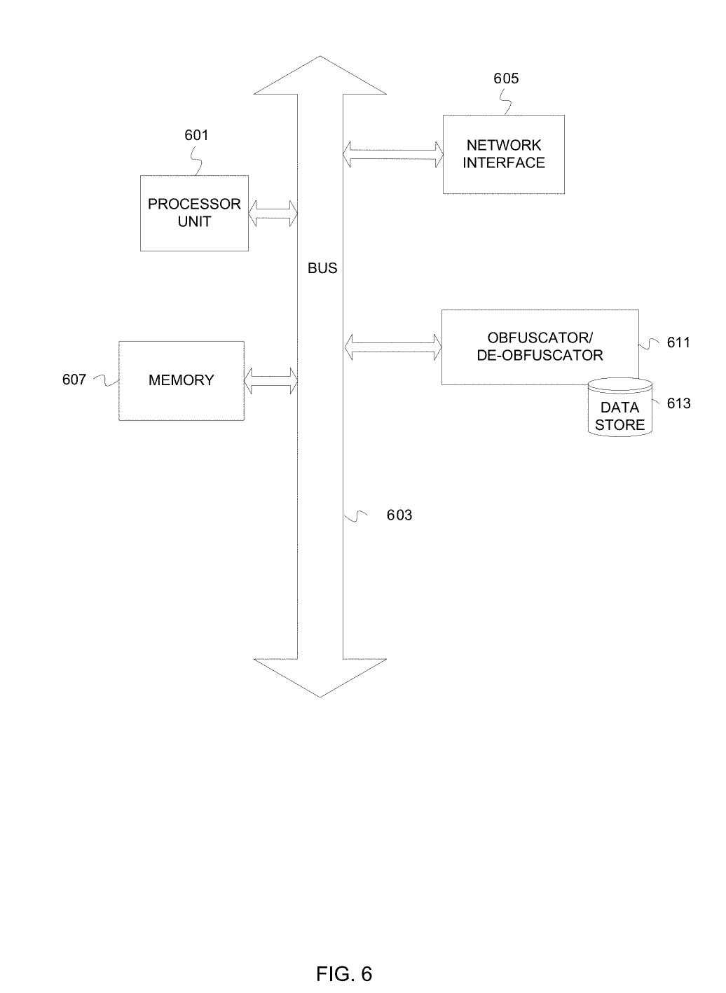

FIG. 6 depicts an example computer system with an obfuscator/de-obfuscator. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes an obfuscator/de-obfuscator 611 and a data store 613. The obfuscator/de-obfuscator 611 determines and obfuscates sensitive values in a document and stores the sensitive values in the data store 613, which is distinct from a data store that will store the non-sensitive values of a document. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for redacting documents as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

The term “agent” as used in the application refers to a process or device for monitoring a component. An agent may be program code that executes on resources of a component or may be a hardware probe. An agent monitors a component to detect transmission of data (e.g., documents, forms) from a client application to a server application. A component may be instrumented with an agent by installing a hardware probe on the component or by initiating a process on the component that executes program code for the agent.

The term “component” as used in this application encompasses both hardware and software resources. The term component may refer to a physical device such as a computer, server, router, etc.; a virtualized device such as a virtual machine or virtualized network function; or software such as an application, a process of an application, database management system, etc. A component may include other components. For example, a server component may include a web service component which includes a web application component.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. The term “cloud destination” and “cloud source” refer to an entity that has a network address that can be used as an endpoint for a network connection. The entity may be a physical device (e.g., a server) or may be a virtual entity (e.g., virtual server or virtual storage device). In more general terms, a cloud service provider resource accessible to customers is a resource owned/manage by the cloud service provider entity that is accessible via network connections. Often, the access is in accordance with an application programming interface or software development kit provided by the cloud service provider.

This disclosure refers to “mapping” and “maps.” Both terms refer to associating or association of data elements or data structures, which can be done with various techniques. As previously mentioned, associating data elements can involve creating a reference to another data element with a memory address, path name, etc. Creating a map or mapping may be creation of a data structure with fields for the data elements being mapped to each other.

This disclosure refers to an event. An event is an occurrence in a system or in a component of the system at a point in time. An event often relates to resource consumption and/or state of a system or system component. As example, an event may be that a document was uploaded to a server. An event can reference or include information about the event and is communicated to by an agent or probe to a component/agent/process that processes the events. Example information about an event includes an event type/code, application identifier, time of the event, severity level, event identifier, event description, etc.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
based on detection of a submit event for a document comprising a plurality of values, determining that a first value of the plurality of values is to be secured;
substituting within the plurality of values an obfuscation value for the first value;
storing in a first repository the first value and an indication that the obfuscation value was substituted for the first value; and
causing the plurality of values with the obfuscation value substituted for the first value to be stored in a second repository which is distinct from the first repository.

2. The method of claim 1 further comprising generating a unique key to access the first value in the first repository.

3. The method of claim 2, wherein the obfuscation value is the unique key.

4. The method of claim 1, wherein storing in the first repository the first value comprises storing the first value in a repository with greater security than the second repository.

5. The method of claim 1, wherein storing in the first repository the first value comprises storing the first value in a repository of a requestor of the submit event, wherein causing the plurality of values with the obfuscation value substituted for the first value to be stored in the second repository comprises communicating the document with the obfuscation value substituted for the first value to a server according to the submit event.

6. The method of claim 1, wherein determining that the first value is to be secured comprises determining that a field or tag associated with the first value is indicated as corresponding to sensitive or confidential data.

7. The method of claim 1 further comprising:
retrieving at least a subset of the plurality of values in response to a request;
determining that the subset of values includes the obfuscation value; and
replacing the obfuscation value with the first value from the first repository based on authorization of a requestor indicated in the request to access the first value.

8. The method of claim 7, further comprising accessing a first mapping that maps the obfuscation value to the first value to determine the first value corresponds to the obfuscation value, wherein the first mapping is stored in the first repository or a third repository that is more secure than the second repository.

9. The method of claim 7 further comprising accessing a first mapping that maps an attribute of the obfuscation value to the first value to determine the first value corresponds to the obfuscation value, wherein the first mapping is stored in the first repository or a third repository that is more secure than the second repository, wherein the attribute indicates a field tag or name corresponding to the obfuscation value, a position of the obfuscation value within the document, or a unique key associated with the obfuscation value.

10. One or more non-transitory machine-readable media comprising program code to restore sensitive values isolated from a redacted document, the program code to:
determine whether a plurality of values retrieved from a first repository in response to a request includes an obfuscation value;
based on a determination that the plurality of values includes one or more obfuscation values,
retrieve from a second repository a set of one or more sensitive values associated with the one or more obfuscation values based, at least in part, on authorization of a requestor of the request;
substitute the one or more sensitive values for respective ones of the one or more obfuscation values; and
communicate the plurality of values with the substituted one or more sensitive values to the requestor.

11. The machine-readable media of claim 10, wherein the program code further comprises program code to determine access authorization of the requestor for each of the one or more sensitive values.

12. The machine-readable media of claim 10, wherein the program code to retrieve the one or more sensitive values comprises program code to, for each of the one or more obfuscation values, determine a mapping from the obfuscation value to a corresponding one of the one or more sensitive values.

13. An apparatus comprising:
a processor; and
a machine-readable medium having program code executable by the processor to cause the apparatus to:
based on detection of a submit event for a document comprising a plurality of values, determine that a first value of the plurality of values is to be secured;
substitute within the plurality of values an obfuscation value for the first value;
store in a first repository the first value and an indication that the obfuscation value was substituted for the first value; and
cause the plurality of values with the obfuscation value substituted for the first value to be stored in a second repository which is distinct from the first repository.

14. The apparatus of claim 13, wherein the program code further comprises program code executable by the processor to cause the apparatus to:
generate a unique key to access the first value in the first repository.

15. The apparatus of claim 14, wherein the obfuscation value is a unique key.

16. The apparatus of claim 13, wherein the program code to store in the first repository the first value comprises program code executable by the processor to cause the apparatus to store the first value in a repository with greater security than the second repository.

17. The apparatus of claim 13, wherein the program code to store in the first repository the first value comprises program code executable by the processor to cause the apparatus to store the first value in a repository of a requestor of the submit event, wherein the program code to cause the plurality of values with the obfuscation value substituted for the first value to be stored in the second repository comprises program code executable by the processor to cause the apparatus to communicate the document with the obfuscation value substituted for the first value to a server according to the submit event.

18. The apparatus of claim 13, wherein the program code to determine that the first value is to be secured comprises program code executable by the processor to cause the apparatus determine that a field or tag associated with the first value is indicated as corresponding to sensitive or confidential data.

19. The apparatus of claim 13, wherein the program code further comprises program code executable by the processor to cause the apparatus to:
retrieve at least a subset of the plurality of values in response to a request;
determine that the subset of values includes the obfuscation value; and
replace the obfuscation value with the first value from the first repository based on authorization of a requestor indicated in the request to access the first value.

20. The apparatus of claim 19, wherein the program code further comprises program code executable by the processor to cause the apparatus to:
access a first mapping that maps the obfuscation value to the first value to determine the first value corresponds to the obfuscation value, wherein the first mapping is stored in the first repository or a third repository that is more secure than the second repository.
